(19) United States
(12) Patent Application Publication
(10) Pub. No.: US 2026/0206826 A1
(43) Pub. Date: Jul. 23, 2026

(54) METHOD AND APPARATUS FOR APPLYING ELONGATE SUSCEPTOR ELEMENTS TO AN AEROSOL-FORMING SUBSTRATE

(71) Applicant: Philip Morris Products S.A., Neuchatel (CH)

(72) Inventors: Oleg MIRONOV, Cudrefin (CH); Andreas Michael ROSSOLL, Le Mont-sur-Lausanne (CH); Alessio DI GIUSEPPE, Modena (IT); Lorenzo BENASSI, Bologna (IT); Julien VIDAL, Peseux (CH)

(73) Assignee: Philip Morris Products S.A., Neuchatel (CH)

(21) Appl. No.: 19/157,860

(22) PCT Filed: Feb. 21, 2024
(86) PCT No.: PCT/EP2024/054411

§ 371 Date: Aug. 19, 2025

(30) Foreign Application Priority Data
Feb. 22, 2023 (EP) 23158023

(51) Int. Cl. A24C 5/01; B65G 47/244

(52) U.S. Cl. CPC A24C 5/01; B65G 47/244

(57) ABSTRACT

A method of applying elongate susceptor elements to an aerosol-forming substrate for an inductively heatable aerosol-generating article is provided, including: providing an aerosol-forming substrate as a sheet material; providing elongate susceptor elements; supplying the elements to a belt conveyor system including a conveyor belt; conveying the elements on the belt towards a discharge end of the system, the belt returning around a magnetic head pulley, which generates a magnetic field causing the elements moving around the pulley to be attracted and aligned along the field, so that when moving out of the field, the elements are discharged from the belt at the discharge end in at least partial alignment to a travel direction; and depositing the elements discharged on a main surface of the sheet material, the substrate being made from a substrate slurry casted into the form of the sheet material, the elements being deposited on the casted slurry.

The present disclosure relates to a method of applying elongate susceptor elements to an aerosol-forming substrate for use in an inductively heatable aerosol-generating article. The present disclosure further relates to an apparatus for applying elongate susceptor elements to an aerosol-forming substrate, in particular for use in a method according to the present disclosure. Aerosol-generating systems using induction heating for generating inhalable aerosols are generally known from prior art. Such systems may comprise an inductively heating aerosol-generating device and a separate aerosol-generating article for use with the device. Among other components, the article may include an aerosol-forming substrate capable to form an inhalable aerosol when heated, and an inductively heatable susceptor arrangement in thermal proximity or direct physical contact with the substrate for heating the same. Inductive heating of the susceptor arrangement is accomplished by interaction of the susceptor arrangement with an alternating magnetic field that is provided by the aerosol-generating device. In operation, the alternating magnetic field induces at least one of heat-generating eddy currents or hysteresis losses in the susceptor arrangement, causing the latter to heat up to a temperature sufficient to release volatile compounds from the heated substrate, which subsequently can cool down to form an aerosol.

Depending on the type of substrate and the shape of the article, different configurations of susceptor element susceptor arrangements are known. As an example, the article may comprise a single solid susceptor element, such as a susceptor strip, that is embedded in a solid or gel-like aerosol-forming substrate within a substrate portion of the article. While solid susceptor element are easily available at low cost, they form a single central heat source which can result in inhomogeneous temperature distribution over the substrate portion. This is because direct heating of the substrate only occurs in the immediate vicinity of the susceptor element, while peripheral regions of the substrate portions are heated only indirectly by means of heat conduction across adjacent substrate layers. In particular, the high temperature gradient may cause the inner regions of the substrate portion in the vicinity of the susceptor element to overheat, whereas the temperature in the peripheral regions of the substrate portion may be too low for volatilizing the substrate. Moreover, the heating efficiency of this configuration is rather sensitive to a proper positioning of the susceptor element within the substrate. All this may cause a non-optimal exploitation of the aerosol-forming substrate. Alternatively, articles have been proposed that comprise spherical or quasi-spherical susceptor particles homogenously disturbed throughout the aerosol-forming substrate. Whilst leading to a more homogenous heating of the substrate, the heating efficiency of this susceptor configuration is limited which may also impact the extraction efficiency.

Therefore, it would be desirable to have an inductively heatable aerosol-forming substrate and an apparatus for manufacturing such an aerosol-forming substrate with the advantages of prior art solutions, whilst mitigating their limitations. In particular, it would be desirable to have an aerosol-forming substrate which provide a more efficient heating and exploitation of the aerosol-forming substrate.

According to an aspect of the present disclosure, there is provided a method of applying elongate susceptor elements to an aerosol-forming substrate for use in an inductively heatable aerosol-generating article. The method comprises the steps of: providing an aerosol-forming substrate in the form a sheet material and of providing elongate susceptor elements. The provided elongate susceptor elements are then supplied to a belt conveyor system comprising a conveyor belt. The elongate susceptor elements are then conveyed on the conveyor belt towards a discharge end of the belt conveyor system, where the conveyor belt returns around a magnetic head pulley. The magnetic head pulley generates a magnetic field causing the elongate susceptor elements moving around the magnetic head pulley to be attracted and aligned along the magnetic field. Subsequently, when moving out of the magnetic field, the elongate susceptor elements are discharged from the conveyor belt at the discharge end in at least partial alignment with respect to a direction of travel. The at least partially aligned elongate susceptor elements discharged from the discharge end of the belt conveyor system are then deposited on a main surface of the sheet material, in particular under the influence of gravity. The sheet material may be provided as a finite sheet material or as a continuous substrate sheet.

As used herein, the term “elongate susceptor element” refers to a susceptor element having a greater extent in one predominant dimension than in the two remaining dimensions perpendicular to the predominant dimension. As such, the elongate susceptor element may also be denoted as 1D-elongate susceptor element (synonym for one-dimensionally-elongate susceptor element) or quasi-1D susceptor element (synonym for quasi-one-dimensional susceptor element). In particular, the term “elongate susceptor element” may refer to a susceptor element that has a length dimension greater than any transverse dimension perpendicular to the length dimension. More particularly, the 1D-elongate susceptor element may be an elongate or a prolate susceptor element.

Although the present invention is described herein with respect to elongate susceptor elements having a length dimension greater than any transverse dimension perpendicular to the length dimension, that is, with respect to 1D-elongate susceptor element having a greater extent in one predominant dimension than in the two remaining dimensions perpendicular to the predominant dimension, it equally applies to susceptor elements having a greater extent in two (perpendicular) predominant dimensions than in the remaining dimension perpendicular to the predominant dimensions. Such susceptor elements may also be denoted as 2D-elongate susceptor elements. In particular, the present invention equally applies to susceptor elements which have a length dimension and a width dimension greater than a thickness direction, wherein the length dimension may be either greater than or substantially similar to the width dimension. More particularly, the present invention equally applies to susceptor elements which have one of an oblate cylindrical shape, such as coin shape, or an oblate-ellipsoidal shape, such as a lens shape, or a flake shape or plate shape. For these susceptor elements, the same features and advantages as described herein with respect to (1D-)elongate susceptor element equally apply and can be equally formulated by basically replacing the term “maximum length dimension of the (1D-)elongate susceptor element(s)” by “maximum extent of the 2D-elongate susceptor element(s) in the two predominant dimensions” and “maximum transverse dimension of the (1D-)elongate susceptor element(s)” by a “maximum extent of the 2D-elongate susceptor element(s) in the remaining (non-prominent) dimension”.

As compared to a single solid susceptor element, usage of a plurality of elongate susceptor elements which are dispersed throughout the aerosol-forming substrate advantageously results in a more homogenous heat distribution over the substrate without any significant temperature gradients across different substrate regions. Furthermore, where the susceptor material of the susceptor elements has a high thermal conductivity, the homogeneity of the heat distribution is further enhanced by the fact that a substrate comprising a plurality of susceptor elements dispersed therein exhibits an increased equivalent thermal conductivity as compared to a substrate without susceptor elements or with a single solid susceptor element only. Moreover, in achieving a homogeneous heat distribution, the proposed susceptor arrangement is less sensitive to the positioning of the susceptor elements as compared to a single solid susceptor element.

Most important, it was found that the geometry, in particular the relative dimensions of the susceptor elements have a major impact on the heating efficiency and thus on the extraction efficiency of the substrate. In this regard, it was found that susceptor elements having an elongate shape are less prone to demagnetization effects as compared to rather equidimensional susceptor elements, such as spherical or quasi-spherical susceptor particles. This can be explained as follows: When placing a susceptor element in an external magnetic field, it becomes progressively magnetized. As the external field increases, so does the internal magnetization. This process continues until the magnetization reaches the magnetic saturation point of the material, beyond which no further magnetization can occur. As a result, the magnetization of the susceptor element causes an accumulation of magnetic charge density at opposite ends of the susceptor element as seen in the direction of the external magnetic field. As a consequence, the susceptor element generates a magnetic field that causes a self-interaction with its material. This field lies along the same direction as the external magnetic field, but points opposite to it, and thus is termed the demagnetization field. The demagnetizing field depends on the geometrical shape of the susceptor element, but not on its absolute dimensions. Provided the susceptor element responds to the external magnetic field changes, the demagnetizing field is generally assumed to be proportional to the magnetization in each direction, related by a geometry dependent constant of proportionality that is known as the demagnetization factor. The demagnetization factor depends on the shape of the susceptor element as well as on its relative orientation to the external magnetic field. To this extent, it has been found that an external magnetic field running through an elongate susceptor element, such as a susceptor element having the shape of a fiber or a thin rod, with a length dimension significantly greater than any transverse dimension perpendicular to the length dimension, generates a weaker or even negligible demagnetization field as compared to a non-elongate (equidimensional) susceptor element, such as a spherical or quasi-spherical susceptor element. This can be intuitively understood since in a properly aligned elongate susceptor element the accumulated magnetic charge densities at the opposite ends of the susceptor element are more spatially distanced from each other. This causes the demagnetizing field to significantly reduce its intensity and thus to have a lesser impact on the magnetization field, which is responsible for the power losses. As a result, power losses and thus heating efficiency is greater than for an elongate susceptor element than for a non-elongate (equidimensional) susceptor element, such as spherical or quasi-spherical susceptor element. This applies especially where the orientation of the magnetic field is substantially parallel to the length dimension of the elongate susceptor element, in which configuration the heating performance is at maximum. Yet, it has been found that the elongate susceptor elements do not necessarily need to be in perfect parallel alignment with the external magnetic field direction. Even if the susceptor elements are aligned in a certain angular range about the orientation of the external magnetic field, the overall heating performance is still higher than for a susceptor arrangement with randomly oriented susceptor elements.

Since the overall heating performance of the elongate susceptor elements increases with a decreasing deviation from an alignment substantially parallel to the alternating magnetic field used for induction heating, the elongate susceptor elements may be aligned preferably such that an angle between the length dimension of the elongate susceptor elements and the direction of travel is in a range between +30 degrees and −30 degrees, preferably between +25 degrees and −25 degrees, in particular between +10 degrees and −10 degrees. Therefore, the elongate susceptor elements may be deposited on the main surface of the sheet material in a similar alignment, thereby increasing the heating performance. As used herein, the terms “(at least) partial alignment” or “(at least) partially aligned” refer to this kind of alignment in the above-defined angular ranges.

As stated above, the heating performance is at maximum for a substantially parallel alignment. Accordingly, the elongate susceptor elements are preferably aligned substantially parallel to the direction of travel. As used herein, the term “substantially parallel” is understood as “parallel ±5° degrees deviation from a parallel arrangement”.

In general, the elongate susceptor elements may be even randomly oriented within the aerosol-forming substrate, although the overall heating performance is lower for a random orientation than for an ensemble of elongate susceptor elements which are aligned in a certain angular range or substantially in parallel to the alternating magnetic field. This is because when considering an ensemble of susceptor elements, the overall heating performance of an ensemble of randomly oriented elongate susceptor elements is still higher on statistical average than that of an ensemble of non-elongate susceptor elements.

With a method/apparatus according to the present disclosure, there is provided a method/apparatus that allows to at least partially align the elongate susceptor elements prior to the deposition of the elongate susceptor elements such that the at least partially aligned elongate susceptor elements can be discharged in at least partial alignment and deposited on the main surface of the sheet material in at least partial alignment.

Whenever in this disclosure a number or a range is given for a plurality of a objects, such as for the plurality of susceptor elements, this means that the number or the range applies to at least 60 percent, in particular at least 70 percent, more particularly at least 80 percent, especially at least 90 percent of all objects out of the plurality of a objects, preferably for all objects out of the plurality of a objects. For example, where the present disclosure states that the elongate susceptor elements are aligned such that an angle between the length dimension of the elongate susceptor elements and the direction of travel is in a range between +A degrees and-A degrees, this means that at least 60 percent, in particular at least 70 percent, more particularly at least 80 percent, especially at least 90 percent of all elongate susceptor elements are aligned such that an angle between the length dimension of the elongate susceptor elements and the direction of travel is in a range between +A degrees and-A degrees.

In order to discharge the elongate susceptor elements on the main surface of the sheet material, in particular only by gravity, the discharge end of the belt conveyor system may be preferably arranged vertically above the sheet material at a place of deposition on the main surface.

As used herein, the term “arranged vertically above” is understood as lying in a projection of a plane of the sheet material or a projection of a plane tangent to the sheet material at the place of deposition above the sheet material.

As used herein, the term “place of deposition” refers to the current surface portion of the sheet material where the elongate susceptor element are deposited at given time during the discharge and deposition process on the main surface of the sheet material.

By providing the discharge end of the belt conveyor system arranged vertically above the sheet material, the elongate susceptor elements may be easily deposited on the main surface of the sheet material by gravity.

Alternatively, the discharge end of the belt conveyor system may be arranged vertically below the sheet material at a place of deposition on the main surface. Therefore, elongate susceptor elements that have not been correctly deposited on the main surface and/or are not adhering to the main surface as desired, for example elongate susceptor elements deposited at least partially overlapping other elongate susceptor elements, would fall off the main surface by gravity. In this arrangement, the elongate susceptor elements are preferably discharged from an upper side of the conveyor belt.

According to another alternative, the discharge end of the belt conveyor system may be preferably arranged horizontally beside the sheet material at a place of deposition on the main surface. As used herein, the term “arranged horizontally beside” is understood as lying in a projection of a plane of the sheet material or a projection of a plane tangent to the sheet material at the place of deposition lateral to the sheet material when the belt conveyor system is in operational conditions.

In order to deposit the elongated susceptor elements on a large surface area of the sheet material, the discharge end of the belt conveyor system and the sheet material may be moved relative to each other during deposition of the elongate susceptor elements on the main surface of the sheet material. This is in particular advantageous when the sheet material is provided as a continuous substrate sheet.

In particular. during depositing the elongate susceptor elements on the main surface of the sheet material, the sheet material may be moved relative (in particular past) to the discharge end of the belt conveyor system in a conveying direction, either continuously or stepwise. The conveying direction preferably being parallel to a plane define by the sheet material or parallel to a plane tangent to the sheet material at a place of deposition.

Upon discharge from the conveyor belt, a projection of the direction of travel of the susceptor elements onto the plane defined by the sheet material or onto the plane tangent to the sheet material at the place of deposition may be preferably substantially parallel to the conveying direction.

Movement of the sheet material relative to (in particular past) the discharge end of the belt conveyor system in the conveying direction, either continuously or stepwise, may be preferably achieved by means of a substrate conveyor belt or by means of one or more rollers.

Again, in order to deposit the elongate susceptor elements on a large surface area of the sheet material, the discharge end of the belt conveyor system may be moved relative to (in particular across) the sheet material in a direction transverse, preferably perpendicular to the conveying direction, during depositing the elongate susceptor elements on the main surface of the sheet material.

In particular, in order to deposit the elongate susceptor elements on a large surface area of the sheet material, during depositing the elongate susceptor elements on the main surface of the sheet material, the discharge end of the belt conveyor system may be moved relative to (in particular across) the sheet material in a plane parallel to a plane defined by the sheet material or parallel to a plane tangent to the sheet material at a place of deposition. Movement may be especially in a direction transverse to the direction of travel of the elongate susceptor elements upon discharge from the conveyor belt and/or in a direction parallel to a projection of direction of travel upon discharge from the conveyor belt onto the plane defined by the sheet material or onto the plane tangent to the sheet material at the place of deposition.

Alignment of the elongate susceptor elements may be preferably achieved with a magnetic head pulley configured as a permanent-magnetic head pulley or as an electro-magnetic head pulley.

The configuration of the magnetic head pulley as a permanent-magnetic head pulley or as an electro-magnetic head pulley may preferably comprise one or more permanent magnets and/or one or more electromagnets. The plurality of magnets may be arranged fixedly or may rotate, in particular rotate together with the magnetic head pulley at the same rotational speed.

In the case where the magnetic head pulley comprises a plurality of permanent magnets, the plurality of permanent magnets may be arranged circumferentially around a rotation axis of the magnetic head pulley within a perimeter of the magnetic head pulley.

Analogously, when the magnetic head pulley comprises a plurality of electromagnets, the plurality of permanent magnets may be arranged circumferentially around a rotation axis of the magnetic head pulley within a perimeter of the magnetic head pulley.

The at least partial alignment of the elongate susceptor elements may be in particular achieved with a configuration where the magnetic field on the outside of the magnetic head pulley extends circumferentially around the magnetic head pulley. In particular when a plurality of permanent magnets and/or electromagnets are comprised by the magnetic head pulley, the magnets may be configured such that the magnetic field extends circumferentially around the magnetic head pulley outside the magnetic head pulley. Preferably the plurality of permanent magnets and/or electromagnets may be configured such that the outmost poles of the magnets with respect to a radial direction of the magnetic head pulley have alternating north poles and south poles, that means, the magnets are arranged such that an outmost north pole of a magnet is followed by an outmost south pole of another magnet along a circumferential direction of the magnetic head pulley. In particular, neighboring magnets may have alternating outmost north and south poles.

Alternatively, the at least partial alignment of the elongate susceptor elements may be achieved with a magnetic field on the outside of the magnetic head pulley extending in parallel to the rotation axis of the magnetic head pulley. In this case, the elongate susceptor elements are at least partially aligned perpendicular to a direction of travel in a plane tangent to the conveyor belt. Accordingly, the elongate susceptor elements may be preferably at least partially aligned such that an angle between a length dimension of the elongate susceptor elements and a direction perpendicular to the direction of travel in a plane tangent to the conveyor belt is in a range between +30 degrees and −30 degrees, preferably +25 degrees and −25 degrees, in particular between +10 degrees and −10 degrees. Preferably, the elongate susceptor elements may be aligned substantially parallel to each other and perpendicular to the direction of travel in a plane tangent to the conveyor belt.

According to another alternative, the al least partial alignment of the elongate susceptor elements may be achieved with a magnetic field on the outside of the magnetic head pulley that causes the elongate susceptor elements to arrange with their length dimension substantially radial to the rotation axis of the magnetic head pulley. In this case, the elongate susceptor elements are at least partially aligned perpendicular to a plane tangent to the conveyor belt. Accordingly, the elongate susceptor elements may be preferably at least partially aligned such that an angle between a length dimension of the elongate susceptor elements and a direction perpendicular to a plane tangent to the conveyor belt is in a range between +30 degrees and −30 degrees, preferably +25 degrees and −25 degrees, in particular between +10 degrees and −10 degrees. Preferably, the elongate susceptor elements may be aligned substantially parallel to each other and perpendicular to a plane tangent to the conveyor belt. Such an alternative is particularly advantageous in a case where a distance between the conveyor belt at the discharge end and the main surface of the sheet material is smaller than a maximum length extension of the elongate susceptor elements, and the belt conveyor system and the sheet material are moved relative to each other. Therefore, the elongate susceptor elements that contact the main surface of the sheet material are peeled off the conveyor belt in at least partial alignment upon contact with the main surface of the sheet material and deposited on the main surface of the sheet material in at least partial alignment. The at least partially aligned elongate susceptor elements may be preferably peeled off at an upper side of the conveyor belt, in particular when the belt conveyor system is arranged vertically below the sheet material, or at a lower side of the conveyor belt, in particular when the belt conveyor system is arranged vertically above the sheet material. Preferably, the sheet material is moved with a linear speed that is greater than the linear speed of the conveyor belt to further enhance alignment with respect to the conveying direction of the sheet material.

For depositing the elongate susceptor elements over the whole width of the sheet material, the belt conveyor system may be preferably configured such that a lateral dimension of the conveyor belt substantially corresponds to a lateral dimension of the sheet material.

The aerosol-forming substrate may be preferably made from a substrate slurry casted into the form of the sheet material, wherein the elongate susceptor elements are deposited on the casted substrate slurry, in particular prior to drying the casted substrate slurry. Depending on the firmness of the casted substrate slurry, the elongate susceptor elements may be at least partially embedded within the substrate sheet after or during deposition.

As already cited above, the aerosol-forming substrate in the form of the sheet material may be a continuous substrate sheet, therefore enabling continuous deposition of the elongate susceptor elements on the continuous substrate sheet.

To further improve manufacturing of the aerosol-forming substrate, the elongate susceptor elements may be deposited on the main surface of the sheet material during or after crimping the continuous substrate sheet, in particular during or after crimping the continuous substrate sheet in a longitudinal direction. The longitudinal direction may be a machine direction of the continuous substrate sheet, preferably parallel to the conveying direction. Deposition of the elongate susceptor elements during or after crimping has the advantage that, since the sheet material is corrugated, the created corrugations are particularly advantageous for accommodating the elongate susceptor elements during depositing, thereby simplifying depositing and also improving alignment and distribution of the elongate susceptor elements.

In order to improve hold of the elongate susceptor elements and to avoid displacement of the elongate susceptor elements, a sticky agent may be applied to the main surface of the sheet material prior to depositing the elongate susceptor elements thereon. The sticky agent may in particular comprise glycerol.

As discussed above, the geometry, in particular the relative dimensions of the elongate susceptor elements have a major impact on the heating efficiency and thus on the extraction efficiency of the substrate. Therefore, the elongate susceptor elements may be selected such as having a ratio of a length dimension to a maximum transverse dimension greater than 4, in particular greater than 10, preferably greater than 20, more preferably greater than 25, even more preferably greater than 30, most preferably greater than 35. The term “maximum transverse dimension” as used herein refers to a greatest dimension of the susceptor wire perpendicular to the predominant dimension (length dimension). This ratio may also be denoted as aspect ratio or form factor.

As used herein, the ratio of the maximum length dimension of an elongate susceptor element to the maximum transverse dimension of the elongate susceptor element perpendicular to the length dimension is also denoted as form factor or aspect ratio. Accordingly, the form factor of the elongate susceptor elements is greater than 4, in particular greater than 10, preferably greater than 20, more preferably greater than 25, even more preferably greater than 30, most preferably greater than 35.

Preferably, the ratio of the maximum length dimension to the maximum transverse dimension (the form factor) does not only have a lower limit but also an upper limit. Accordingly, the ratio of the maximum length dimension to the maximum transverse dimension of the elongate susceptor elements perpendicular to the (maximum) length dimension, that is, the form factor of the elongate susceptor elements may be a range between 4 and 500, in particular between 10 and 300, preferably between 20 and 200, more preferably between 30 and 100.

In absolute values, a length dimension of the elongate susceptor elements may be in a range between 20 micrometer and 50 millimeter, in particular 100 micrometer and 16 millimeter, preferably between 0.5 millimeter and 5 millimeter. Such maximum length dimensions prove advantageous with regard to deposition according to the present disclosure.

Depending on the respective absolute values of the maximum length dimension, the respective absolute value of the maximum transverse dimension of the elongate susceptor elements is preferably chosen such that the form factor is above the above-defined lower limit, advantageously also within the above-defined preferred ranges. Accordingly, a maximum transverse dimension of the elongate susceptor elements may be in a range between 5 micrometer and 500 micrometer, in particular 10 micrometer and 150 micrometer, preferably 80 micrometer and 120 micrometer. In particular, a maximum transverse dimension of the elongate susceptor elements may be equal to or smaller than 500 micrometer, in particular 100 micrometer, preferably 50 micrometer, more preferably 25 micrometer.

The heating efficiency also depends on the density of the elongate susceptor elements within the aerosol-forming substrate. The higher the density, the larger the heating efficiency. Preferably, a (volume) density of the elongate susceptor elements within the aerosol-forming substrate is in a range between 0.001 susceptor elements per cubic millimeter and 30 susceptor elements per cubic millimeter, in particular between 0.1 susceptor elements per cubic millimeter and 10 susceptor elements per cubic millimeter. Likewise, a mass density of the elongate susceptor elements within the aerosol-forming substrate may be in a range between 0.002 milligram of susceptor mass per cubic millimeter and 0.3 milligram susceptor mass per cubic millimeter, in particular between 0.01 milligram of susceptor mass per cubic millimeter and 0.1 milligram of susceptor mass per cubic millimeter.

In general, the susceptor elements may have any geometrical shape, as long as it is elongate. In particular, the elongate susceptor elements may have one of a cylindrical shape or a prolate-ellipsoidal shape. That is, the elongate susceptor elements may have a rod-like shape or a grain-like shape.

As an example, the elongate susceptor elements may be fiber elements, in particular chopped fiber elements or milled fiber elements. As another example, the elongate susceptor elements may be wire elements or thread elements or grain elements or rod elements. Advantageously, the fiber elements or the wire elements or the thread elements or the grain elements or the filament elements or the rod elements are made of a material that is inductively heatable, such as metal fibers, or metal wires or metal threads, are easily available at low cost.

As seen in a plane perpendicular to the length dimension of the elongate susceptor element, a cross-section of the elongate susceptor elements may have a circular shape or an oval shape or an elliptical shape or a triangular shape or a rectangular shape or a quadratic shape or polygonal shape. If the cross-section is circular, the above-mentioned maximum transverse dimension of the elongate susceptor elements corresponds to the diameter of the susceptor elements where it is at maximum along the length dimension of the elongate susceptor elements. If the cross-section is oval or elliptical, the above-mentioned maximum transverse dimension of the susceptor elements corresponds to the length of the semimajor axis of the oval or elliptical cross-section, where it is at maximum along the length dimension of the elongate susceptor elements. If the cross-section is quadratic or in general rectangular, the above-mentioned maximum transverse dimension of the susceptor elements corresponds to the length of the edge/major edge of the quadratic/rectangular cross-section.

In general, the term “susceptor element” as used herein refers to an element comprising a susceptor material that is capable to convert electromagnetic energy into heat when subjected to an alternating magnetic field. This may be the result of at least one hysteresis losses and eddy currents induced in the susceptor material, depending on the electrical and magnetic properties of the susceptor material. Hysteresis losses occur in ferromagnetic or ferrimagnetic susceptor materials due to magnetic domains within the material being switched under the influence of an alternating electromagnetic field. Eddy currents may be induced, if the susceptor material is electrically conductive. In case of an electrically conductive ferromagnetic susceptor or an electrically conductive ferrimagnetic susceptor, heat can be generated due to both, eddy currents and hysteresis losses.

Accordingly, the elongate susceptor elements may be in general at least one of electrically conductive and either ferromagnetic or ferrimagnetic. In particular, the susceptor material of the elongate susceptor elements may be electrically non-conductive, but either ferromagnetic or ferrimagnetic. Alternatively, the susceptor material of the elongate susceptor elements may be electrically conductive, but neither ferromagnetic nor ferrimagnetic.

Preferably, the susceptor material of the elongate susceptor elements may comprises or consists of a metal, for example ferritic iron, or stainless steel, in particular a grade 410, grade 420, or grade 430 stainless steel; or a ferrimagnetic ceramic.

In addition to the susceptor material, the elongate susceptor elements further comprise a ferromagnetic or ferrimagnetic marker material.

While the susceptor material is optimized with regard to heat loss and thus heating efficiency, the temperature marker material is a magnetic (ferro-or ferrimagnetic) material that is chosen such as to have a Curie temperature which essentially corresponds to a predefined temperature point of the heating process.

The temperature marker material may have a Curie temperature below 500° C., preferably equal to or below 400° C., in particular equal to or below 390° C. For example, the temperature marker material of the elongate susceptor elements may have a Curie temperature in a range between 180° C. and 420° C., in particular between 210° C. and 380° C., preferably between 250°C. and 380° C. Even though the temperature marker material primarily is a functional material providing a temperature marker by its Curie temperature, it may also contribute to the inductive heating process of the susceptor arrangement.

The temperature marker material of the elongate susceptor elements may comprise or may consist of nickel or a nickel alloy.

The susceptor elements may be formed such that the susceptor material is surrounded or covered at least partially, preferably entirely by the temperature marker material.

In addition, the elongate susceptor elements may comprise an outer protective coating surrounding the susceptor material an—if present—the temperature marker material. Preferably, the protective coating makes the elongate susceptor elements resistant to external influences, especially corrosive influences.

The provided elongate susceptor elements may have substantially identical characteristics such as susceptor material, maximum extent, form ratio, temperature marker material, outer coating etc. Alternatively, a mixture of elongate susceptor elements with different characteristics may be provided.

It is also possible that the susceptor material of the susceptor elements itself has a temperature marker function. That is, the elongate susceptor elements may comprise a single material which acts both as a susceptor material and as a temperature marker material.

The present disclosure also relates to an apparatus for applying elongate susceptor elements to an aerosol-forming substrate. The apparatus may be in particular suited for use in a method according to the present disclosure. Therefore, the above description applies accordingly to the apparatus according to the present disclosure.

The apparatus may comprise a belt conveyor system, the belt conveyor system comprising a conveyor belt returning around a magnetic head pulley at a discharge end of the belt conveyor system. The magnetic head pulley is configured to generate a magnetic field causing the elongate susceptor elements on the conveyor belt moving around the magnetic head pulley to be attracted and aligned along the magnetic field, such that subsequently—when moving out of the magnetic field—the elongate susceptor elements are discharged from the conveyor belt at the discharged end in at least partial alignment with respect to a direction of travel.

The elongate susceptor elements may be preferably provided via a susceptor supply. The susceptor supply may be in particular a hopper. The susceptor supply may be coupled to the belt conveyor system for providing and supplying elongate susceptor elements to the conveyor belt upstream of the discharge end.

The aerosol-forming substrate in the form a sheet material may be preferably provided via a substrate supply to or past the discharge end of the belt conveyor system. The sheet material may be in particular provided vertically below the discharge end of the belt conveyor system, enabling to deposit the at least partially aligned elongate susceptor elements discharged from the discharge end of the belt conveyor system on the main surface of the sheet material, preferably under the influence of gravity.

The substrate supply may preferably comprise a conveyor belt or one or more rollers for providing the aerosol-forming substrate in the form the sheet material past the discharge end of the belt conveyor system in a conveying direction, either continuously or stepwise. The conveying direction may be preferably parallel to a plane defined by the sheet material or parallel to a plane tangent to the sheet material at a place of deposition when being provided past the discharge end.

For providing optimal deposition of the elongate susceptor elements on the sheet material, the at least one guide channel may be preferably configured and arranged such that a projection of the direction of travel of the elongate susceptor elements upon discharge from the conveyor belt onto the plane defined by the sheet material or onto the plane tangent to the sheet material at the place of deposition when being provided past the discharge end is substantially parallel to the conveying direction.

The belt conveyor system may be preferably configured such that the discharge end is movable relative to (in particular across) the sheet material in a direction transverse, preferably perpendicular to the conveying direction.

To further improve deposition of the elongate susceptor elements on a large surface area of the sheet material, the belt conveyor system may be in particular configured such that the discharge end is movable relative to (in particular across) the sheet material in a plane parallel to a plane defined by the sheet material or parallel to a plane tangent to the sheet material at a place of deposition when being provided to or past the discharge end. Movement may be preferably in a direction transverse to the direction of travel of the elongate susceptor elements upon discharge from the conveyor belt and/or in a direction parallel to a projection of the direction of travel of the elongate susceptor elements upon discharge from the conveyor belt onto the plane defined by the sheet material or onto the plane tangent to the sheet material at the place of deposition when being provided to or past the discharge end.

The magnetic head pulley may be a permanent-magnetic head pulley or an electro-magnetic head pulley, and may comprise one or more permanent magnets and/or one or more electromagnets.

In a preferred configuration, the magnetic head pulley may comprise a plurality of permanent magnets arranged circumferentially around a rotation axis of the magnetic head pulley within a perimeter of the magnetic head pulley and/or a plurality of electromagnets arranged circumferentially around a rotation axis of the magnetic head pulley within a perimeter of the magnetic head pulley.

The magnetic field on the outside of the magnetic head pulley may preferably extend at least circumferentially around the magnetic head pulley. Alternatively, the magnetic field on the outside of the magnetic head pulley may extend at least partially in parallel to a rotation axis of the magnetic head pulley.

As used herein, the term “aerosol-generating article” refers to an article comprising at least one aerosol-forming substrate that is capable of releasing volatile compounds when heated in order to form an aerosol. The aerosol-generating article may be a consumable, in particular a consumable to be discarded after a single use. For example, the article may be an elongate article or a rod-shaped article. The elongate or rod-shaped article may have a shape resembling the shape of conventional cigarettes. In particular, such an article may have a circular or elliptical or oval or square or rectangular or triangular or a polygonal cross-section. As another example, the article may be a cartridge including a liquid aerosol-forming substrate to be heated.

As used herein, the term “aerosol-forming substrate” denotes a substrate formed from or comprising an aerosol-forming material that is capable of releasing volatile compounds upon heating in order to generate an aerosol. Preferably, the aerosol-forming substrate is intended to be heated rather than combusted in order to release the aerosol-forming volatile compounds. Accordingly, such a substrate may be denoted as a heat-not-burn aerosol-forming substrate. Likewise, an aerosol-generating article comprising such an aerosol-forming substrate may be denoted as a heat-not-burn aerosol-generating article.

In general, the aerosol-forming substrate may comprise at least one aerosol former and at least one sensorial material both of which are volatilizable when heated. The sensorial material may comprise at least one of a tobacco-containing material, a nicotine-containing material and a flavoring substance. Examples of suitable aerosol formers are glycerin and propylene glycol. Examples of flavoring substance may be plant extracts and natural or artificial flavors.

The aerosol-forming substrate may be a solid aerosol-forming substrate, a gel-like aerosol-forming substrate, or any combination thereof.

As mentioned above, the aerosol-forming substrate may comprise a tobacco-containing material containing volatile tobacco flavor compounds, which are released from the substrate upon heating. In particular, the aerosol-forming substrate may comprise reconstituted tobacco material or a tobacco-containing slurry. Accordingly, the aerosol-generating article may be a tobacco containing article. Alternatively or additionally, the aerosol-forming substrate may comprise a non-tobacco material. The aerosol-forming substrate may also comprise other additives and ingredients, such as nicotine or flavourants.

The aerosol-forming substrate may also be a paste-like material, a sachet of porous material comprising aerosol-forming substrate, or, for example, loose tobacco mixed with a gelling agent or sticky agent, which could include a common aerosol former such as glycerin, and which The aerosol-forming substrate is made from a sheet material. For example, the aerosol-forming substrate may be made from a crimped tobacco sheet comprising a tobacco material, organic fibers, a binder, an aerosol former. Alternatively, the aerosol-forming substrate may be made from a sheet material including a nicotine-containing material, organic fibers, a binder, an aerosol former. As yet another alternative, the aerosol-forming substrate may be made from a sheet material containing tobacco cut filler. To this extent, it has been found that the aerosol-generating article is easy to manufacture, especially with respect to a preferred alignment of the elongate susceptor elements relative to a pre-defined reference axis of the article, if the susceptor elements are applied to the aerosol-forming substrate when it is in the form of a sheet material. This may be the result of a manufacturing process including the deposition of the susceptor elements on an outer surface of a sheet material, either during a primary process, in which the sheet material is produced, or during a secondary process, where the sheet material is machined and combined with other semi-finished goods to obtain the final product. As a result of this, the elongate susceptor elements may be finally disposed on an outer surface of the sheet material or at least partially embedded in the sheet material close to an outer surface of the sheet material. This can be observed even if the sheet material is subsequently machined, for example, crimped and gathered such as to form a substrate plug in the final article.

The invention is defined in the claims. However, below there is provided a non-exhaustive list of non-limiting examples. Any one or more of the features of these examples may be combined with any one or more features of another example, embodiment, or aspect described herein.

Example Ex1: A method of applying elongate susceptor elements to an aerosol-forming substrate for use in an inductively heatable aerosol-generating article, the method comprising the steps of: providing an aerosol-forming substrate in the form a sheet material; providing elongate susceptor elements; supplying the elongate susceptor elements to a belt conveyor system comprising a conveyor belt; conveying the elongate susceptor elements on the conveyor belt towards a discharge end of the belt conveyor system, where the conveyor belt returns around a magnetic head pulley which generates a magnetic field causing the elongate susceptor elements moving around the magnetic head pulley to be attracted and aligned along the magnetic field, such that subsequently—when moving out of the magnetic field—the elongate susceptor elements are discharged from the conveyor belt at the discharge end in at least partial alignment with respect to a direction of travel; and depositing the elongate susceptor elements discharged from the discharge end of the belt conveyor system on a main surface of the sheet material, in particular under the influence of gravity.

Example Ex2: The method according to example Ex1, wherein the elongate susceptor elements are aligned at least partially such that an angle between a length dimension of the elongate susceptor elements and the direction of travel is in a range between +30 degrees and−30 degrees, preferably +25 degrees and −25 degrees, in particular between +10 degrees and −10 degrees; or wherein the elongate susceptor elements are aligned at least partially such that an angle between a length dimension of the elongate susceptor elements and a direction perpendicular to the direction of travel in a plane tangent to the conveyor belt is in a range between +30 degrees and −30 degrees, preferably +25 degrees and −25 degrees, in particular between +10 degrees and −10 degrees.

Example Ex3: The method according to example Ex1, wherein the elongate susceptor elements are aligned substantially parallel to each other along the direction of travel or along a direction perpendicular to the direction of travel in a plane tangent to the conveyor belt.

Example Ex4: The method according to any one of the preceding examples Ex1 to Ex3, wherein the discharge end of the belt conveyor system is arranged vertically above the sheet material at a place of deposition on the main surface.

Example Ex5: The method according to any one of the preceding examples Ex1 to Ex4, wherein during depositing the elongate susceptor elements on the main surface of the sheet material, the discharge end of the belt conveyor system and the sheet material are moved relative to each other.

Example Ex6: The method according to any one of the preceding examples Ex1 to Ex5, wherein during depositing the elongate susceptor elements on the main surface of the sheet material, the sheet material is moved relative (in particular past) to the discharge end of the belt conveyor system in a conveying direction, the conveying direction preferably being parallel to a plane defined by the sheet material or parallel to a plane tangent to the sheet material at a place of deposition.

Example Ex7: The method according to example Ex6, wherein-upon discharge from the conveyor belt-a projection of the direction of travel of the susceptor elements onto the plane defined by the sheet material or onto the plane tangent to the sheet material at the place of deposition is substantially parallel to the conveying direction.

Example Ex8: The method according to any one of examples Ex6 or Ex7, wherein the sheet material is moved relative to (in particular past) the discharge end of the belt conveyor system in the conveying direction by means of a substrate conveyor belt or by means of one or more rollers.

Example Ex9: The method according to any one of examples Ex6 to Ex8, wherein during depositing the elongate susceptor elements on the main surface of the sheet material, the discharge end of the belt conveyor system is moved relative to (in particular across) the sheet material in a direction transverse, preferably perpendicular to the conveying direction of the sheet material.

Example Ex10: The method according to any one of the preceding examples Ex1 to Ex9, wherein during depositing the elongate susceptor elements on the main surface of the sheet material, the discharge end of the belt conveyor system is moved relative to (in particular across) the sheet material in a plane parallel to a plane defined by the sheet material or parallel to a plane tangent to the sheet material at a place of deposition, especially in a direction transverse to the direction of travel of the elongate susceptor elements upon discharge from the conveyor belt and/or in a direction parallel to a projection of the direction of travel of the susceptor elements upon discharge from the conveyor belt onto the plane defined by the sheet material or onto the plane tangent to the sheet material at the place of deposition.

Example Ex11: The method according to any one of the preceding examples Ex1 to Ex10, wherein the magnetic head pulley is a permanent-magnetic head pulley or an electro-magnetic head pulley.

Example Ex12: The method according to any one of the preceding examples Ex1 to Ex11, wherein the magnetic head pulley comprises one or more permanent magnets and/or one or more electromagnets.

Example Ex13: The method according to any one of the preceding examples Ex1 to Ex12, wherein the magnetic head pulley comprises a plurality of permanent magnets arranged circumferentially around a rotation axis of the magnetic head pulley within a perimeter of the magnetic head pulley.

Example Ex14: The method according to any one of the preceding examples Ex1 to Ex13, wherein the magnetic head pulley comprises a plurality of electromagnets arranged circumferentially around a rotation axis of the magnetic head pulley within a perimeter of the magnetic head pulley.

Example Ex15: The method according to any one of the preceding examples Ex1 to Ex14, wherein the magnetic field on the outside of the magnetic head pulley extends at least partially circumferentially around the magnetic head pulley; or wherein the magnetic field on the outside of the magnetic head pulley extends at least partially in parallel to a rotation axis of the magnetic head pulley.

Example Ex 16: The method according to any one of the preceding examples Ex 1 to Ex 15, wherein a lateral dimension of the conveyor belt substantially corresponds to a lateral dimension of the sheet material.

Example Ex17: The method according to any one of the preceding examples Ex1 to Ex16, wherein the aerosol-forming substrate is made from a substrate slurry casted into the form of the sheet material, wherein the elongate susceptor elements are deposited on the casted substrate slurry.

Example Ex18: The method according to example Ex17, wherein the elongate susceptor elements are deposited on the main surface of the sheet material prior to drying the casted substrate slurry.

Example Ex19: The method according to any one of the preceding examples Ex1 to Ex18, wherein the aerosol-forming substrate in the form of the sheet material is a continuous substrate sheet.

Example Ex20: The method according to example Ex19, wherein the elongate susceptor elements are deposited on the main surface of the sheet material during or after crimping the continuous substrate sheet, especially during or after crimping the continuous substrate sheet in a longitudinal direction, in particular in a machine direction of the continuous substrate sheet.

Example Ex21: The method according to any one of the preceding examples Ex1 to Ex20, wherein a sticky agent is applied to the main surface of the sheet material prior to depositing the susceptor elements thereon.

Example Ex22: The method according to example Ex21, wherein the sticky agent comprises glycerol.

Example Ex23: The method according to any one of the preceding examples Ex1 to Ex22, wherein a ratio of a length dimension to a maximum transverse dimension of the elongate susceptor elements is greater than 4, in particular greater than 10, preferably greater than 20, more preferably greater than 25, even more preferably greater than 30, most preferably greater than 35.

Example Ex24: The method according to any one of the preceding examples Ex1 to Ex23, wherein a ratio of the length dimension to a maximum transverse dimension of the elongate susceptor elements is in a range between 4 and 500, in particular between 10 and 300 preferably between 20 and 200, more preferably between 30 and 100.

Example Ex25. The method according to any one of the preceding examples Ex1 to Ex24, wherein a length dimension of the elongate susceptor elements is in a range between 20 micrometer and 50 millimeter, in particular 100 micrometer and 16 millimeter, preferably between 0.5 millimeter and 5 millimeter.

Example Ex26: The method according to any one of the preceding examples Ex1 to Ex25, wherein a maximum transverse dimension of the elongate susceptor elements is a range between 5 micrometer and 500 micrometer, in particular 10 micrometer and 150 micrometer, preferably 80 micrometer and 120 micrometer.

Example Ex27: The method according to any one of the preceding examples Ex1 to Ex26, wherein a maximum transverse dimension of the elongate susceptor elements is equal to or smaller than 500 micrometer, in particular 100 micrometer, preferably 50 micrometer, more preferably 25 micrometer.

Example Ex28: The method according to any one of the preceding examples Ex1 to Ex27, wherein the elongate susceptor elements have one of a cylindrical shape or a prolate-ellipsoidal shape.

Example Ex29: The method according to any one of the preceding examples Ex1 to Ex28, wherein the elongate susceptor elements are one of fiber elements, in particular chopped fiber elements or milled fiber elements, or wire elements, or thread elements, or grain elements or rod elements.

Example Ex30: The method according to any one of the preceding examples Ex1 to Ex29, wherein a cross-section of the elongate susceptor elements in a plane perpendicular to the length dimension of the susceptor element has a circular shape or an oval shape or an elliptical shape or a triangular shape or a rectangular shape or a quadratic shape or polygonal shape.

Example Ex31: The method according to any one of the preceding examples Ex1 to Ex30, wherein the elongate susceptor elements comprise a susceptor material which is at one of electrically conductive and either ferromagnetic or ferrimagnetic.

Example Ex32: The method according to example Ex31, wherein the susceptor material of the elongate susceptor elements comprises or consists of a metal, for example ferritic iron, or stainless steel, in particular a grade 410, grade 420, or grade 430 stainless steel; or a ferrimagnetic ceramic.

Example Ex33: The method according to any one examples Ex31 or Ex32, wherein the elongate susceptor elements further comprise a ferromagnetic or ferrimagnetic temperature marker material in addition to the susceptor material.

Example Ex34: The method according to example Ex33, wherein the temperature marker material of the elongate susceptor elements comprises or consists of nickel or a nickel alloy.

Example Ex35: An apparatus for applying elongate susceptor elements to an aerosol-forming, in particular for use in a method according to any one of the preceding examples Ex1 to Ex34, the apparatus comprising a belt conveyor system which comprise a conveyor belt returning around a magnetic head pulley at a discharge end of the belt conveyor system, wherein the magnetic head pulley is configured to generate a magnetic field causing the elongate susceptor elements on the conveyor belt moving around the magnetic head pulley to be attracted and aligned along the magnetic field, such that subsequently—when moving out of the magnetic field—the elongate susceptor elements are discharged from the conveyor belt at the discharged end in at least partial alignment with respect to a direction of travel.

Example Ex36: The apparatus according to example Ex35, further comprising a susceptor supply, in particular a hopper, coupled to the belt conveyor system arranged and configured for providing and supplying elongate susceptor elements to the conveyer belt upstream of the discharge end.

Example Ex37: The apparatus according to any one of examples Ex35 or Ex36, further comprising a substrate supply for providing an aerosol-forming substrate in the form a sheet material to or past the discharge end of the belt conveyor system, in particular vertically below the discharge end of the belt conveyor system, enabling to deposit the elongate susceptor elements discharged from the discharge end of the belt conveyor system on the main surface of the sheet material, preferably under the influence of gravity.

Example Ex38: The apparatus according to example Ex37, wherein the substrate supply comprises a substrate conveyor belt or one or more rollers for providing the aerosol-forming substrate in the form the sheet material past the discharge end of the belt conveyor system in a conveying direction, the conveying direction preferably being parallel to a plane defined by the sheet material or parallel to a plane tangent to the sheet material at a place of deposition when being provided past the discharge end of the belt conveyor system.

Example Ex39: The apparatus according to example Ex38, wherein the belt conveyor system is configured such that the discharge end is movable relative to (in particular across) the sheet material in a direction transverse, preferably perpendicular to the conveying direction.

Example Ex40: The apparatus according to any one of example Ex35 to Ex39, wherein the belt conveyor system is configured such that the discharge end is movable relative to (in particular across) the sheet material in a plane parallel to a plane defined by the sheet material or parallel to a plane tangent to the sheet material at a place of deposition when being provided to or past the discharge end, especially in a direction transverse to the direction of travel of the elongate susceptor elements upon discharge from the conveyor belt and/or in a direction parallel to a projection of the direction of travel of the elongate susceptor elements upon discharge from the conveyor belt onto the plane defined by the sheet material or onto the plane tangent to the sheet material at the place of deposition.

Example Ex41: The apparatus according to any one of examples Ex35 to Ex40, wherein the magnetic head pulley is a permanent-magnetic head pulley or an electro-magnetic head pulley.

Example Ex42: The apparatus according to any one of examples Ex35 to Ex41, wherein the magnetic head pulley comprises one or more permanent magnets and/or one or more electromagnets.

Example Ex43: The apparatus according to any one of examples Ex35 to Ex42, wherein the magnetic head pulley comprises a plurality of permanent magnets arranged circumferentially around a rotation axis of the magnetic head pulley within a perimeter of the magnetic head pulley. Example Ex44: The apparatus according to any one of examples Ex35 to Ex43, wherein the magnetic head pulley comprises a plurality of electromagnets arranged circumferentially around a rotation axis of the magnetic head pulley within a perimeter of the magnetic head pulley. Example Ex45: The apparatus according to any one of examples Ex35 to Ex44, wherein the magnetic field on the outside of the magnetic head pulley extends at least partially circumferentially around the magnetic head pulley; or wherein the magnetic field on the outside of the magnetic head pulley extends at least partially in parallel to a rotation axis of the magnetic

Examples will now be further described with reference to the figures in which:

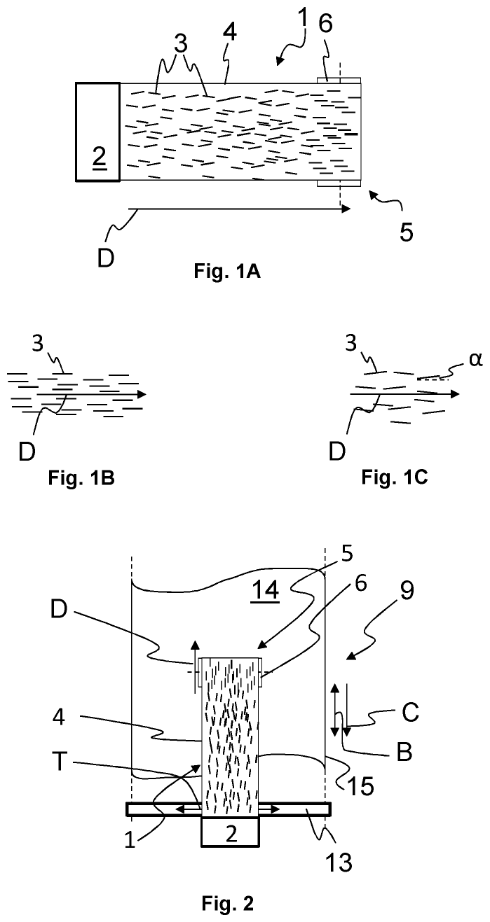

FIG. 1A schematically shows a belt conveyor system in top view according to the present invention;

FIG. 1B schematically shows a detail of substantially parallel aligned susceptor elements;

FIG. 1C schematically shows a detail of partially aligned susceptor elements;

FIG. 2 schematically shows a top view of an apparatus according to an embodiment of the present invention;

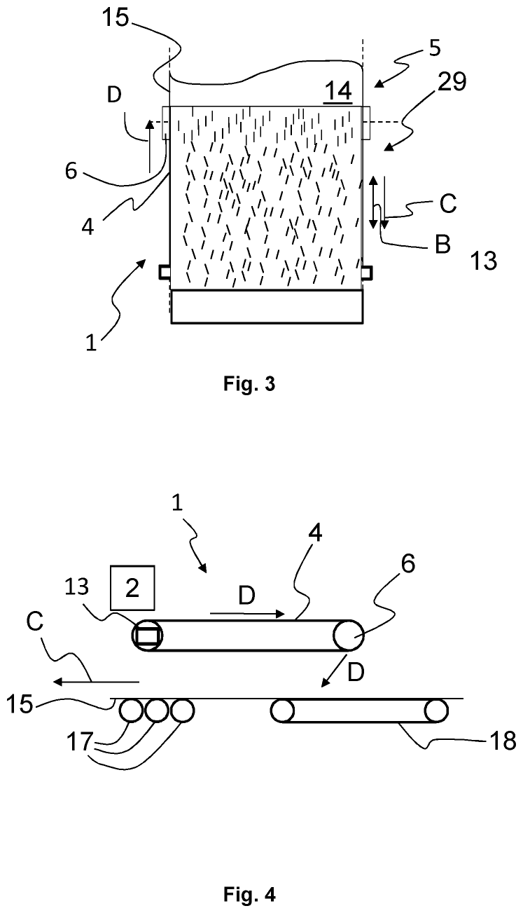

FIG. 3 schematically shows a top view of an apparatus according to another embodiment of the present invention;

FIG. 4 schematically shows a side view of an apparatus according to an embodiment of the present invention;

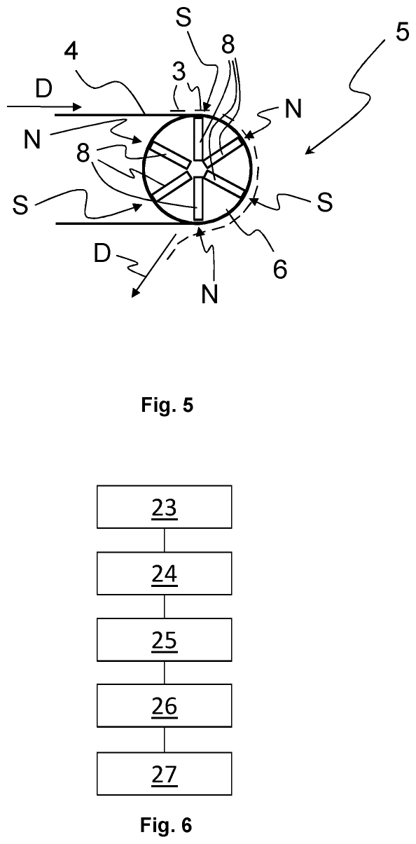

FIG. 5 schematically shows a side view of an apparatus according to another embodiment of the present invention;

FIG. 6 schematically shows a flow chart of a method according to the present invention;

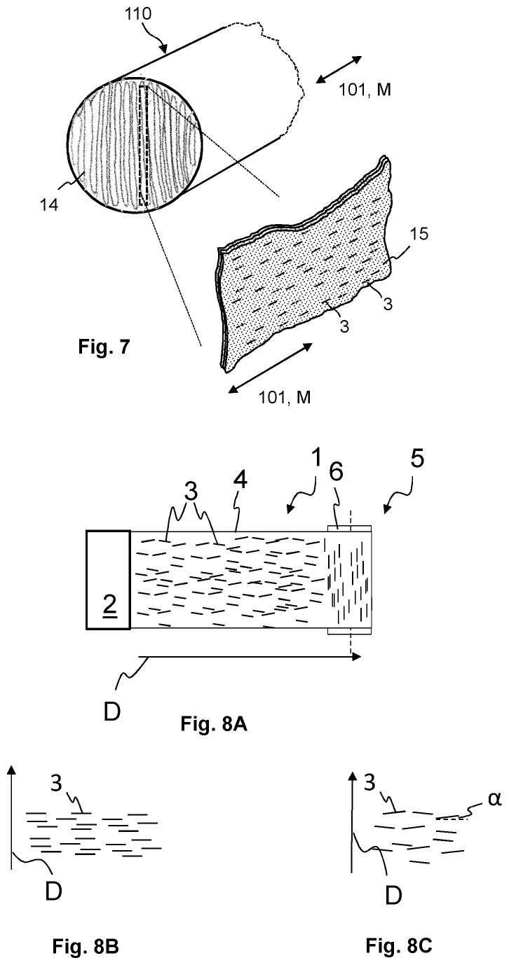

FIG. 7 schematically and in detail shows a substrate element comprising elongated susceptor elements;

FIG. 8A schematically shows a belt conveyor system in top view according to another embodiment of the present invention;

FIG. 8B schematically shows a detail of substantially parallel aligned susceptor elements; and FIG. 8C schematically shows a detail of partially aligned susceptor elements.

All the examples shown in the figures are schematic and not to scale.

In FIG. 1A, an example of a belt conveyor system 1 is shown schematically in a top view. A hopper 2 is arranged upstream of the belt conveyor system 1 to provide elongate susceptor elements 3 to a conveyor belt 4. The conveyor belt 4 is configured to convey the provided elongate susceptor elements 3 along a direction of travel D towards a discharge end 5 of the belt conveyor system 1. The conveyor belt 4 returns around a magnetic head pulley 6. The magnetic head pulley 6 is configured to generate a magnetic field that causes the elongate susceptor elements 3 moving around the magnetic head pulley 6 to be aligned along the generated magnetic field. In the example shown in FIG. 1A, the elongate susceptor elements 3 are conveyed along the direction of travel D from left to right. Accordingly, the elongate susceptor elements 3 on the right side of FIG. 1A are aligned substantially parallel to each other, as compared to the elongate susceptor elements 3 on the left side of FIG. 1A. This is due to the magnetic field generated by the magnetic head pulley 6, which, in the example of FIG. 1A, extends at least partially circumferentially around the magnetic head pulley 6. When the elongate susceptor elements 3 move out of the magnetic field, they are discharged from the conveyor belt 4 at the discharge end 5 (on the lower side of the conveyor belt 4) aligned substantially parallel to each other and to the direction of travel D. From there, they are subsequently deposited on a main surface of the sheet material, in particular under the influence of gravity, aligned substantially parallel to each other and to the direction of travel.

In the example shown in FIG. 1A, the elongate susceptor elements 3 are discharged in a substantially parallel alignment to each other and to the direction of travel D on a main surface of an aerosol forming substrate provided as a sheet material, as shown in detail in FIG. 1B. In this case, the elongate susceptor elements 3 may be also deposited substantially parallel to a projection of the direction of travel D onto a plane defined by the sheet material or onto a plane tangent to the sheet material at a place of deposition.

Alternatively, as shown in the detail of FIG. 1C, the elongate susceptor elements 3 may be discharged in at least partial alignment, wherein an angle alpha (a) between a length dimension, of the elongated susceptor elements 3 and the direction of travel D is in a range between +30 degrees and −30 degrees, in particular +25 degrees and −25 degrees, preferably between +10 degrees and −10 degrees, and deposited on a main surface of an aerosol-forming substrate provided as a sheet material. Accordingly, the elongate susceptor elements 3 may be deposited in a least partial alignment to a projection of the direction of travel D onto a plane defined by the sheet material or onto a plane tangent to the sheet material at a place of deposition. In this case, the angle alpha (a) is the angle between a length dimension of the elongated susceptor elements 3 and the projection of the direction of travel D onto the plane defined by the sheet material or onto the plane tangent to the sheet material at the place of deposition.

FIG. 2 schematically shows an apparatus 9 according to the present invention in top view. The apparatus 9 comprises a belt conveyor system 1 comprising a conveyor belt 4 fed by a hopper 2, as shown in FIG. 1, mounted on a beam 13. An aerosol-forming substrate 14 is provided in the form of a sheet material 15 to the apparatus 9 below the belt conveyor system 1 and may be conveyed past the belt conveyor system 1 in a conveying direction C, either continuously or stepwise. The conveying direction C in the example of FIG. 2 is parallel to a plane defined by the sheet material 15 (corresponding to the drawing plane). A projection of the direction of travel D of the elongate susceptor elements onto the plane defined by the sheet material 15 is also parallel to the conveying direction C. The belt conveyor system 1 is movably mounted on the beam 13 and is moved transversely across the sheet material 15 in a transverse direction T perpendicular to the conveying direction C, schematically denoted by the double-arrow. The sheet material 15 may be a continuous substrate sheet, as schematically shown in FIG. 2, or a finite substrate sheet. The sheet material 15 may be conveyed in the conveying direction C past the belt conveyor system 1 continuously or stepwise. The movement of the belt conveyor system 1 along the transverse direction T allows for the deposition of the elongate susceptor elements 3 over the whole width of the sheet (which lies in the drawing plane and is perpendicular to the conveying direction C) with a reduced amount of belt conveyor systems 1. As an example, one belt conveyor system 1 as shown in FIG. 2 may be provided, wherein the belt conveyor system 1 moves along the transverse direction T over the whole width of the sheet material 15 and is configured for depositing the elongate susceptor elements 3 over the whole width of the sheet material 15. Alternatively, two or more belt conveyor systems 1 may be provided mounted on the beam 13, each of the belt conveyor systems 1 being movable along the transverse direction T and configured for depositing the elongate susceptor elements 3 on a respective width portion of the sheet material 15. The elongate susceptor elements 3 are discharged from the belt conveyor system 1 and deposited on a main surface of the sheet material 15 in at least partial alignment as shown in FIGS. 1A, 1B and 1C.

FIG. 3 shows another example of an apparatus 29 according to the present invention in top view. The apparatus 29 comprises a belt conveyor system 1 comprising a conveyor belt 4 mounted on the beam 13. In the example shown in FIG. 3, the conveyor belt 4 has a lateral dimension corresponding to the lateral dimension of the sheet material 15, that means, that the conveyor belt 4 covers the whole width of the sheet material 15. An aerosol-forming substrate 14 is provided in the form of a sheet material 15 to the apparatus 29 below the belt conveyor system 1 and may be conveyed past the belt conveyor system 1 in a conveying direction C. The conveying direction C in the example of FIG. 3 is parallel to a plane defined by the sheet material 15 (corresponding to the drawing plane). A projection of the direction of travel D onto the plane defined by the sheet material 15 is also parallel to the conveying direction C. The sheet material 15 may be a continuous substrate sheet, as schematically shown in FIG. 3, or a finite substrate sheet. The sheet material 15 may be conveyed in the conveying direction C past the belt conveyor system 1 continuously or stepwise. Providing a conveyor belt 4 with a lateral dimension corresponding to the lateral dimension of the sheet material 15, as shown in FIG. 3, allows for the deposition of the elongate susceptor elements 3 over the whole width of the sheet material 15 without the need of providing movement of the belt conveyor system 1 as shown in FIG. 2. Such a combination is however possible. The elongate susceptor elements 3 are discharged from the belt conveyor system 1 and deposited on a main surface of the sheet material 15 in at least partial alignment as shown in FIGS. 1A, 1B and 1C.

Additionally or alternatively, beam 13 may be moved relative to the sheet material 15. In the examples shown in FIGS. 2 and 3, the beam 13 may be moved in a beam direction parallel to the conveying direction C, even in the case where the sheet material 15 is not conveyed, as shown schematically by the double arrow B.

In FIG. 4, a schematic, simplified lateral view of an apparatus according to the present invention is shown. The apparatus of FIG. 4 may be constructed according to the apparatuses 9 and 29 of FIGS. 2 and 3. The at least one belt conveyor system 1 is arranged above the sheet material 15 on the beam 13. The sheet material 15 is conveyed in the conveying direction C parallel to a plane defined by the sheet material 15. The sheet material 15 may be conveyed by means or one or more rollers 17 and/or one or more conveyor belts 18 in the conveying direction C, either continuously or stepwise. The conveyor belt 4 of the belt conveyor system 1 returns over the magnetic head pulley 6 that generates a magnetic field for aligning the elongate susceptor elements 3 conveyed on the conveyor belt 4 in the direction of travel D. The magnetic head pulley 6 may be a permanent-magnetic head pulley or an electro-magnetic head pulley.

In FIG. 5, a preferred embodiment of the magnetic head pulley 6 is shown schematically in more detail. The magnetic head pulley 6 comprises a plurality of magnets 8 arranged circumferentially within the magnetic head pulley 6 around the rotation axis of the magnetic head pulley 6. The magnets 8, which may be electromagnets and/or permanent magnets, may rotate with the magnetic head pulley 6 or their position may be fixed. Furthermore, the magnets 8 are arranged and configured such that a magnetic field for at least partially aligning the elongate susceptor elements 3 extends at least partially circumferentially around the magnetic head pulley 6, at least in the portion of the magnetic head pulley 6 where the elongate susceptor elements 3 travel around the magnetic head pulley 6 before being discharged as they move out of the magnetic field of the magnetic head pulley 6. For a better understanding, in FIG. 5 a gap is shown between the elongate susceptor elements 3 and the conveyor belt 4 for distinguishing the elongate susceptor elements 3 from the conveyor belt 4. The elongate susceptor elements 3 are discharged from the conveyor belt in at least partial alignment along a direction of travel D. The magnets 8 may be arranged having alternating outmost magnetic north poles N and south poles S along a circumferential direction of the magnetic head pulley 6 for generating the aligning magnetic field extending at least partially circumferentially around the magnetic head pulley 6. Thereby, the elongate susceptor elements 3 are at least partially aligned and subsequently discharged at the discharge end 5 in at least partial alignment.

In FIG. 6, a flow chart of a method according to the present invention is shown. The method of applying elongate susceptor elements 3 to an aerosol-forming substrate 14 for use in an inductively heatable aerosol-generating article according to the present invention may be performed with an apparatus according to the present invention, as described above. In a first step 23, an aerosol-forming substrate 14 is provided in the form of a sheet material 15. In a second step 24, elongate susceptor elements 3 are provided. In a subsequent step 25, the elongate susceptor elements 3 provided in step 24 are then supplied to a belt conveyor system 1 comprising a conveyor belt 4. In step 26, the elongate susceptor elements 3 are conveyed on the conveyor belt 4 towards a discharge end 5 of the belt conveyor system 1, where the conveyor belt 4 returns around a magnetic head pulley 6 which generates a magnetic field A causing the elongate susceptor elements 3 moving around the magnetic head pulley 6 to be attracted and aligned along the magnetic field A, such that subsequently-when moving out of the magnetic field A-the elongate susceptor elements 3 are discharged from the conveyor belt 4 at the discharge end 5 in at least partial alignment with respect to a direction of travel D. In step 27, the elongate susceptor elements 3 are discharged from the discharge end 5 of the belt conveyor system 1 and deposited on a main surface of the sheet material 15, in particular under the influence of gravity.

FIG. 7 shows a perspective view of a portion of a substrate element 110 forming part of a rod-shaped aerosol-generating article, including a detailed view (bottom right) of its inner structure, in particular the structure of aerosol-forming substrate 14 and the elongate susceptor elements 3. As can be seen from both, the perspective view and the detailed view, the aerosol-forming substrate 14 is made from a sheet material 15 that has been gathered into the cylindrical shape of the substrate element 110 upon having deposited elongate susceptor elements thereon. For example, the aerosol-forming substrate 14 may be made from a crimped tobacco sheet comprising a tobacco material, organic fibers, a binder, an aerosol. As can be further seen from the detailed view, the elongate susceptor elements 3 are deposited on the main surface of the sheet material 15 which can be still observed even though the sheet material 15 is crimped and gathered. This may be the result of a manufacturing process including the deposition of the susceptor elements 3 on a main surface of the sheet material 15 according to the present invention, either during a primary process, in which the sheet material 15 is produced, or during a secondary process, where the sheet material 15 is machined. The elongate susceptor elements 3 within the substrate element 110 are all aligned along their length dimension (predominant dimension) substantially in parallel with a pre-defined reference axis of the aerosol-generating article, here the length axis 101 of the article, which is chosen such that in use it coincides with the orientation M of the field lines of an alternating magnetic field used to inductively heat the elongate susceptor elements 3, for example when the aerosol-generating article is engaged with an aerosol-generating device providing the alternating magnetic field. As mentioned before, the heating efficiency is at maximum if the elongate susceptor elements 3 are all aligned in parallel to the orientation M of the alternating magnetic field.

In FIG. 8A, an example of a belt conveyor system 1 according to another embodiment of the present invention is shown schematically in a top view. The belt conveyor system substantially corresponds to the belt conveyor system shown in FIG. 1A. A hopper 2 is arranged upstream of the belt conveyor system 1 to provide elongate susceptor elements 3 to a conveyor belt 4. The conveyor belt 4 is configured to convey the provided elongate susceptor elements 3 along a direction of travel D towards a discharge end 5 of the belt conveyor system 1. The conveyor belt 4 returns around a magnetic head pulley 6. The magnetic head pulley 6 is configured to generate a magnetic field that causes the elongate susceptor elements 3 moving around the magnetic head pulley 6 to be aligned along the generated magnetic field. As in the example shown in FIG. 1A, in this example, the elongate susceptor elements 3 are conveyed along the direction of travel from left to right. Opposed to the example shown in FIG. 1A, the elongate susceptor elements 3 on the right side of FIG. 8A are aligned substantially parallel to each other, but perpendicular to the direction of travel D in a plane tangent to the conveyor belt 4. This is due to the magnetic field generated outside of the magnetic head pulley 6, which, in the example of FIG. 8A, extends in parallel to the rotation axis of the magnetic head pulley 6. When the elongate susceptor elements 3 move out of the magnetic field, they are discharged from the conveyor belt 4 at the discharge end 5 aligned substantially parallel to each other and perpendicular to the direction of travel D in a plane tangent to the conveyor belt 4, and are subsequently deposited on a main surface of the sheet material, in particular under the influence of gravity, aligned substantially parallel to each other.

FIG. 8B schematically shows, in analogy to FIG. 1B, the elongate susceptor elements 3 discharged in a substantially parallel alignment to each other and perpendicular to the direction of travel D on a main surface of an aerosol forming substrate provided as a sheet material. In this case, the elongate susceptor elements 3 may be also deposited substantially perpendicular to a projection of the direction of travel D onto a plane defined by the sheet material or onto a plane tangent to the sheet material at a place of deposition.

Alternatively, as shown in the detail of FIG. 8C, the elongate susceptor elements 3 may be discharged in at least partial alignment, wherein an angle alpha (a) between a length dimension, of the elongated susceptor elements 3 and a direction perpendicular to the direction of travel D is in a range between +30 degrees and −30 degrees, in particular +25 degrees and −25 degrees, preferably between +10 degrees and −10 degrees, and deposited on a main surface of an aerosol-forming substrate provided as a sheet material. Accordingly, the elongate susceptor elements 3 may be discharged and deposited in a least partial alignment to a projection of a perpendicular to the direction of travel D onto a plane defined by the sheet material or onto a plane tangent to the sheet material at a place of deposition. In this case, the angle alpha (a) is the angle between a length dimension of the elongated susceptor elements 3 and the projection of a perpendicular to the direction of travel D onto the plane defined by the sheet material or onto the plane tangent to the sheet material at the place of deposition.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-14. (canceled)

15. A method of applying elongate susceptor elements to an aerosol-forming substrate for an inductively heatable aerosol-generating article, the method comprising the steps of:
providing an aerosol-forming substrate in the form of a sheet material;
providing elongate susceptor elements;
supplying the elongate susceptor elements to a belt conveyor system comprising a conveyor belt;
conveying the elongate susceptor elements on the conveyor belt towards a discharge end of the belt conveyor system, where the conveyor belt returns around a magnetic head pulley, which generates a magnetic field causing the elongate susceptor elements moving around the magnetic head pulley to be attracted and aligned along the magnetic field, such that subsequently, when moving out of the magnetic field, the elongate susceptor elements are discharged from the conveyor belt at the discharge end in at least partial alignment with respect to a direction of travel; and
depositing the elongate susceptor elements discharged from the discharge end of the belt conveyor system on a main surface of the sheet material,
wherein the aerosol-forming substrate is made from a substrate slurry casted into the form of the sheet material, and wherein the elongate susceptor elements are deposited on the casted substrate slurry.

16. The method according to claim 15, wherein the depositing the elongate susceptor elements is under influence of gravity.

17. The method according to claim 15, wherein the elongate susceptor elements are aligned substantially parallel to each other along the direction of travel or along a direction perpendicular to the direction of travel in a plane tangent to the conveyor belt.

18. The method according to claim 15, wherein during depositing the elongate susceptor elements on the main surface of the sheet material, the sheet material is moved relative to the discharge end of the belt conveyor system in a conveying direction.

19. The method according to claim 18, wherein the conveying direction is parallel to a plane defined by the sheet material or parallel to a plane tangent to the sheet material at a place of deposition.

20. The method according to claim 15, wherein the magnetic head pulley is a permanent-magnetic head pulley or an electro-magnetic head pulley.

21. The method according to claim 15, wherein the magnetic head pulley comprises one or more permanent magnets and/or one or more electromagnets.

22. The method according to claim 15, wherein the magnetic head pulley comprises a plurality of permanent magnets arranged circumferentially around a rotation axis of the magnetic head pulley within a perimeter of the magnetic head pulley.

23. The method according to claim 15, wherein the magnetic head pulley comprises a plurality of electromagnets arranged circumferentially around a rotation axis of the magnetic head pulley within a perimeter of the magnetic head pulley.

24. The method according to claim 15,
wherein the magnetic field on the outside of the magnetic head pulley extends at least partially circumferentially around the magnetic head pulley, or
wherein the magnetic field on the outside of the magnetic head pulley extends at least partially in parallel to a rotation axis of the magnetic head pulley.

25. The method according to claim 15, wherein the elongate susceptor elements are deposited on the main surface of the sheet material prior to drying the casted substrate slurry.

26. The method according to claim 15, wherein the aerosol-forming substrate in the form of the sheet material is a continuous substrate sheet.

27. The method according to claim 26, wherein the elongate susceptor elements are deposited on the main surface of the sheet material during or after crimping the continuous substrate sheet in a longitudinal direction of the continuous substrate sheet.

28. The method according to claim 26, wherein the elongate susceptor elements are deposited on the main surface of the sheet material during or after crimping the continuous substrate sheet in a machine direction of the continuous substrate sheet.

29. The method according to claim 15, wherein a sticky agent is applied to the main surface of the sheet material prior to depositing the susceptor elements thereon.

30. An apparatus for applying elongate susceptor elements to an aerosol-forming substrate in the method according to claim 15, the apparatus comprising an aerosol-forming substrate supply, an elongated susceptor elements supply, and a belt conveyor system, which comprises a conveyor belt returning around a magnetic head pulley at a discharge end of the belt conveyor system, wherein the magnetic head pulley is configured to generate a magnetic field causing the elongate susceptor elements on the conveyor belt moving around the magnetic head pulley to be attracted and aligned along the magnetic field, such that subsequently, when moving out of the magnetic field, the elongate susceptor elements are discharged from the conveyor belt at the discharged end in at least partial alignment with respect to a direction of travel, wherein the aerosol-forming substrate is made from a substrate slurry casted into the form of a sheet material, and wherein the belt conveyor system is configured to deposit the elongate susceptor elements on the casted substrate slurry.

31. The apparatus according to claim 30,
wherein the magnetic field on the outside of the magnetic head pulley extends at least partially circumferentially around the magnetic head pulley, or
wherein the magnetic field on the outside of the magnetic head pulley extends at least partially in parallel to a rotation axis of the magnetic head pulley.
